(19) United States
(12) Patent Application Publication
(10) Pub. No.: US 2025/0379356 A1
(43) Pub. Date: Dec. 11, 2025

(54) RADIO FREQUENCY PACKAGES AND METHODS FOR MANUFACTURING THEREOF

(71) Applicant: Infineon Technologies AG, Neubiberg (DE)

(72) Inventors: Tuncay ERDÖL, Unterhaching (DE); Ernst SELER, München (DE)

(21) Appl. No.: 19/220,341

(22) Filed: May 28, 2025

(30) Foreign Application Priority Data
Jun. 7, 2024 (DE) 102024205260.4

(51) Int. Cl. H01Q 1/52; H01Q 1/22; H01Q 13/22

(52) U.S. Cl. CPC H01Q 1/526; H01Q 1/2283; H01Q 13/22

(57) ABSTRACT

A radio frequency (RF) package includes an RF chip, a coupling element configured to couple an RF signal into or out of the RF package, an RF signal path coupling the RF chip and the coupling element, and a waveguide arranged in the RF signal path, wherein the waveguide is arranged inside the RF package and includes a first metal layer, a second metal layer opposite the first metal layer and a first slot formed in the first metal layer, wherein a main portion of the first slot is arranged perpendicular to a propagation direction of the waveguide.

### CROSS-REFERENCE TO RELATED APPLICATION

This application claims priority to Germany Patent Application No. 102024205260.4filed on Jun. 7, 2024, the content of which is incorporated by reference herein in its entirety.

### TECHNICAL FIELD

The present disclosure relates to radio frequency (RF) packages and methods for manufacturing RF packages.

### BACKGROUND

For radio frequency (RF) transmitter or transceiver packages (such as radar systems), out-of-band radiation may violate EMI/EMC (Electromagnetic Interference/Electromagnetic Compatibility) requirements. For example, an important component of out-of-band radiation may occur at the second harmonic of the fundamental frequency band. Conventional RF packages may implement complex and costly precautions to suppress undesired out-of-band output.

Manufacturers and developers of RF packages are constantly striving to improve their products. In the above context, it may be desirable to provide RF packages with low out-of-band output that fulfil EMI/EMC requirements. In addition, it may be desirable to provide simple and cost-efficient methods for manufacturing such RF devices.

### SUMMARY

An aspect of the present disclosure relates to a radio frequency (RF) package. The RF package includes an RF chip, a coupling element configured to couple an RF signal into or out of the RF package, an RF signal path coupling the RF chip and the coupling element, and a waveguide arranged in the RF signal path. The waveguide is arranged inside the RF package and includes a first metal layer, a second metal layer opposite the first metal layer and a first slot formed in the first metal layer, wherein a main portion of the first slot is arranged perpendicular to a propagation direction of the waveguide.

A further aspect of the present disclosure relates to a method for manufacturing an RF package. The method includes an act of generating an RF chip. The method further includes an act of generating a coupling element configured to couple an RF signal into or out of the RF package. The method further includes an act of coupling the RF chip and the coupling element via an RF signal path. The method further includes an act of generating a waveguide in the RF signal path, wherein the waveguide is arranged inside the RF package and includes a first metal layer and a second metal layer opposite the first metal layer. The method further includes an act of forming a first slot in the first metal layer, wherein a main portion of the first slot is arranged perpendicular to a propagation direction of the waveguide.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 schematically illustrates a cross-sectional side view of an RF package 100 in accordance with the disclosure.

FIGS. 2A and 2B illustrate a cross-sectional side view and a perspective view of a substrate integrated waveguide (SIW) 200 which may be included in an RF package in accordance with the disclosure.

FIGS. 3A to 3C illustrate a cross-sectional side view, a top view and a perspective view of an SIW 300 which may be included in an RF package in accordance with the disclosure.

FIG. 4 illustrates a top view of an SIW 400 which may be included in an RF package in accordance with the disclosure.

FIG. 5 illustrates a top view of an SIW 500 which may be included in an RF package in accordance with the disclosure.

FIG. 6 illustrates a top view of an SIW 600 which may be included in an RF package in accordance with the disclosure.

FIGS. 7A and 7B illustrates electrical field distributions of a TE10 mode and a TE20 mode of a waveguide.

FIGS. 8A to 8C illustrate various insertion losses for a conventional waveguide and a waveguide in accordance with the disclosure.

FIG. 9 illustrates a flowchart of a method for manufacturing an RF device in accordance with the disclosure.

### DETAILED DESCRIPTION

In the following detailed description, reference is made to the accompanying drawings, in which are shown by way of illustration specific aspects in which the disclosure may be practiced. In this regard, directional terminology, such as “top”, “bottom”, “front”, “back”, or the like may be used with reference to the orientation of the figures being described. Since components of described devices may be positioned in a number of different orientations, the directional terminology may be used for purposes of illustration and is in no way limiting. Other aspects may be utilized and structural or logical changes may be made without departing from the concept of the present disclosure. Hence, the following detailed description is not to be taken in a limiting sense, and the concept of the present disclosure is defined by the appended claims.

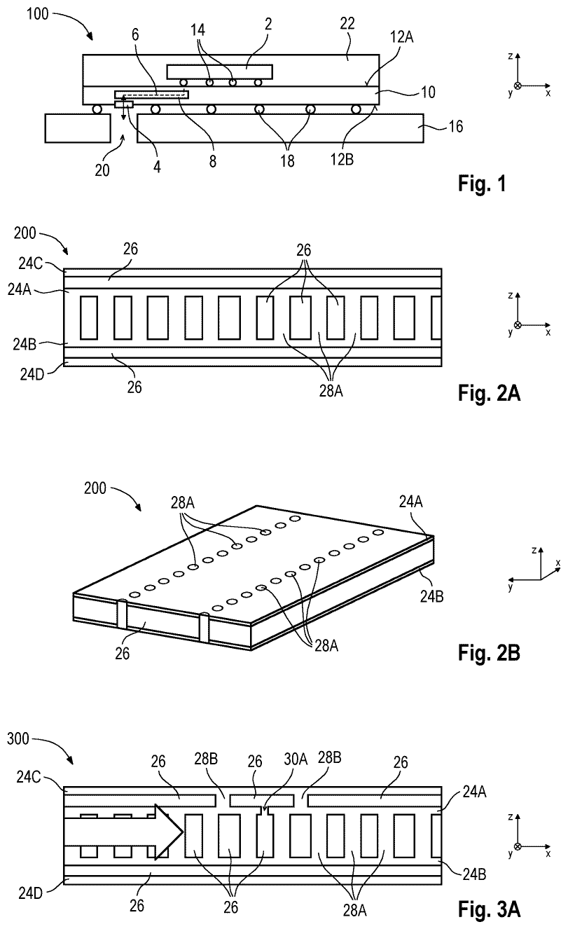

Referring now to FIG. 1, an example radio frequency (RF) package 100 in accordance with the disclosure is shown. For example, the RF package 100 may be an FCBGA (Flip Chip Ball Grid Array) package. However, is to be understood that the present discourse is not restricted to such package type, but may also be practiced in RF packages of different type and design. The RF package 100 may include an RF chip 2 and a coupling element 4, which may be coupled by an RF signal path 6 indicated by a dashed line. The coupling element 4 may be configured to couple an RF signal into or out of the RF package 100 as indicated by a bidirectional arrow. The RF package 100 may further include a waveguide 8 arranged in the RF signal path 6, wherein the waveguide 8 may be arranged inside the RF package 100. Detailed designs and structures of example waveguides that may be used in RF packages in accordance with the disclosure are shown and described below. In the illustrated example, the RF package 100 may include a substrate 10, wherein the RF chip 2 may be arranged on a first main surface 12A of the substrate 10 and the coupling element 4 may be arranged at a second main surface 12B of the substrate 10 opposite the first main surface 12A. The waveguide 8 may be arranged in the substrate 10.

The substrate 10 may include a dielectric material and multiple metal layers which are not shown for the sake of simplicity. The metal layers may be arranged on the first main surface 12A, on the second main surface 12B and/or in the dielectric material and may in particular extend in the x-y-plane. Metal layers arranged on different levels with respect to the z-direction may be electrically connected by electrically conductive via connections extending through the dielectric material. In particular, the waveguide 8 arranged in the substrate 10 may be formed by the metal layers and the dielectric material. The RF chip 2 may be electrically and mechanically coupled to the first main surface 12A of the substrate 10 by multiple electrical connection elements 14. In particular, the electrical connection elements 14 may provide an electrical connection between electrical contacts of the RF chip 2 and one or more metal layers arranged on the first main surface 12A of the substrate 10.

The RF chip 2 may be made of or may include an arbitrary semiconductor material, such as e.g., silicon. The RF chip 2 (or electronic circuits thereof) may be configured to operate in a frequency range of greater than about 1 GHz, in some examples greater than about 10 GHz. The RF chip 2 may thus also be referred to as radio frequency chip or high frequency chip or microwave frequency chip. More particular, the RF chip 2 may be configured to operate in an RF range or microwave frequency range, which may range from about 1 GHz to about 1 THz, more particular from about 10 GHz to about 300 GHz. Microwave circuits may include, for example, microwave transmitters, microwave receivers, microwave transceivers, microwave sensors, microwave detectors, or the like. RF devices in accordance with the disclosure may be used for radar applications in which the frequency of the RF signals may be modulated. The RF chip 2 may thus also be referred to as radar chip. In particular, the RF chip 2 may include or may correspond to an MMIC (Monolithic Microwave Integrated Circuit).

Radar microwave devices may e.g., be used in automotive, industrial, military and/or defense applications for range and speed measuring systems. For example, automotive applications may include advanced driver assistant systems, automatic vehicle cruise control systems, vehicle anti-collision systems, or the like. Such systems may operate in the microwave frequency range and may utilize FMCW (Frequency Modulation Continuous Wave) signals, for example in the 24 GHZ, 76 GHZ, or 79 GHz frequency bands. A use of radar microwave systems may provide constant and efficient driving of vehicles. An efficient driving style may, for example, reduce fuel consumption such that CO₂ emission may be reduced and energy savings may be enabled. In addition, abrasion of vehicle tires, brake discs and brake pads may be reduced, thereby reducing fine dust pollution. Improved RF or radar systems, as specified herein, may thus contribute to green technology solutions, e.g., climate-friendly solutions providing reduced energy usage.

The coupling element 4 may be configured to couple RF signals into or out of the substrate 10. Accordingly, the coupling element 4 may be referred to as transmission/reception element and/or the RF package 100 may be referred to as RF transceiver package. In the illustrated example, a single coupling element 4 is shown for the sake of simplicity. However, in further examples, the RF package 100 may include additional coupling elements, the number of which may depend on or may correspond to a number of RF channels of the RF chip 2. In particular, each coupling element 4 may be associated with a respective RF channel of the RF chip 2. In some examples, the coupling element 4 may include or may correspond to one or multiple antennas which may e.g., be formed in one or more of the metal layers of the substrate 10. In the illustrated example, the coupling element 4 may be arranged at the second main surface 12B of the substrate 10.

The RF package 100 may be mounted on a printed circuit board (PCB) 16 which may be seen as a part of the RF package 100 or not. A mechanical and electrical connection between the substrate 10 and the PCB 16 may be established by multiple electrical connections elements 18, such as solder balls or solder depots. The PCB 16 may include at least one opening 20 aligned to the coupling element 4 and extending through the PCB 16 in the z-direction. In some examples, the RF package 100 may include at least one waveguide antenna (not shown), wherein the coupling element 4 may be configured to couple RF signals via the aligned opening 20 to the respective waveguide antenna and/or vice versa. In this context, the RF package 100 may include an AFIP (Antenna Feed In Package), wherein the coupling element 4 may correspond to a launcher or a launcher structure. The launcher may be coupled to a respective RF port of the RF chip 2 to transfer an RF signal between the RF port and a waveguide antenna.

The RF package 100 may optionally include an encapsulation material 22 which may at least partially encapsulate components of the RF package 100. In the illustrated example, the encapsulation material 22 may be arranged on the first main surface 12A of the substrate 10 and may at least partially cover the RF chip 2. The encapsulation material 22 may include or may be made of at least one of an epoxy, a filled epoxy, a glass fiber filled epoxy, an imide, a thermoplast, a thermoset polymer, a polymer blend, a mold compound, or the like. Various techniques may be used for encapsulating components of the RF package 100 in the encapsulation material 22, for example at least one of compression molding, injection molding, powder molding, liquid molding, map molding, or the like.

Referring now to FIGS. 2A and 2B, a cross-sectional side view and a perspective view of a substrate integrated waveguide (SIW) 200 are shown. FIGS. 2A and 2B only shows a portion of the SIW 200 which can further extend in the x-direction. For example, the SIW 200 may be arranged in the RF package 100 of FIG. 1. In some transceiver packages, SIWs may be used as a main RF transmission structure due to their robustness against manufacturing tolerances. The SIW 200 may include a first metal layer 24A, a second metal layer 24B opposite the first metal layer 24A and a dielectric material 26 arranged between the first metal layer 24A and the second metal layer 24B. Referring back to the example of FIG. 1, the metal layers 24A, 24B and the dielectric material 26 of the SIW 200 may be part of or may be arranged in the substrate 10. The first metal layer 24A may be referred to as a top metal layer of the SIW 200, and the second metal layer 24B may be referred to as a bottom metal layer of the SIW 200. The SIW 200 may include a first plurality of first via connections 28A that may extend between the first metal layer 24A and the second metal layer 24B. The first via connections 28A may be arranged to form a via fence.

The SIW 200 may be composed of the dielectric material 26 covered on both faces by the first metal layer 24A and the second metal layer 24B. The dielectric material 26 may embed the first via connections 28A that may form two parallel rows of metallic via holes delimiting a propagation area of electromagnetic waves that are to be transmitted via the SIW 200. The propagating electromagnetic waves may be confined within the dielectric material 26 by the metal layers 24A and 24B on each of the two surfaces of the dielectric material 26 and between the two rows of the first metallic vias 28A connecting the metal layers 24A and 24B. In the illustrated example, the SIW 200 may be configured to transmit electromagnetic waves in the x-direction. In other words, a propagation direction of the SIW 200 may extend in the x-direction. The SIW 200 may further include a third metal layer 24C arranged over the first metal layer 24A and a fourth metal layer 24D arranged below the second metal layer 24B. Note that the metal layers 24C and 24D are not illustrated in the perspective view of FIG. 2B for illustrative purposes. In the illustrated example, the dielectric material 26 may also be arranged between the first metal layer 24A and the third metal layer 24C as well as between the second metal layer 24B and the fourth metal layer 24D.

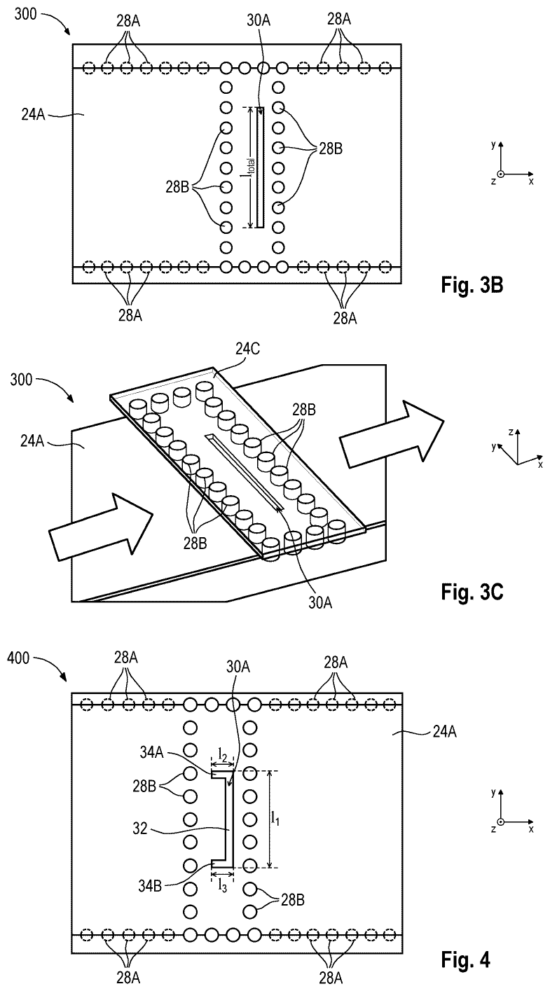

Referring now to FIGS. 3A to 3C, a cross-sectional side view, a top view and a perspective view of an SIW 300 are shown. The SIW 300 of FIGS. 3A to 3C may include some or all features of the SIW 200 of FIGS. 2A and 2B. FIG. 3 only shows a portion of the SIW 300 which may further extend in the x-direction. For example, the SIWs 200 and 300 of FIGS. 2 and 3 may be seen as two portions of the same SIW. The SIW 300 may be arranged in an RF package in accordance with the disclosure such as the RF package 100 of FIG. 1. The SIW 300 may include a first slot 30A formed in the first metal layer 24A, wherein a main portion of the first slot 30A may be arranged perpendicular to a propagation direction of the SIW 300. In the illustrated example, the propagation direction of the SIW 300 may extend in the x-direction, while the first slot 30A may extend in the y-direction. An example propagation of an RF signal through the SIW 300 is indicated by an arrow pointing in the x-direction. In general, a position of the first slot 30A with respect to the x-direction may be chosen arbitrarily and may inter alia depend on the design and the structure of the RF package 100. In particular, the first slot 30A may be arranged at a position along the SIW 300, e.g., not necessarily at the position of an input or an output of the SIW 300, but anywhere between.

In the non-limiting example of FIGS. 3A to 3C, the first slot 30A may have a straight or linear shape. A total length lₜₒₜₐₗ of the first slot 30A may substantially equal λ/2, wherein λ is a wavelength (or effective wavelength) at the position of the first slot 30A associated with the second harmonic of an operating frequency of the RF chip 2. The total length lₜₒₜₐₗ of the first slot 30A may be adapted to the signal frequency and/or may be used for tuning the frequency. The (effective) wavelength λ of electromagnetic radiation transmitted in the SIW 300 may depend on various properties. For example, the wavelength λ may depend on the dimensions and the shape of the SIW 300. The wavelength of electromagnetic radiation in a waveguide may be directly related to the physical dimensions of the waveguide, such as the width, height, and length of the waveguide. The dimensions of the waveguide may determine the modes of propagation that can exist within the waveguide, which in turn affects the wavelength of the radiation. Furthermore, the wavelength λ may depend on the material of the SIW 300. The wavelength of electromagnetic radiation in a waveguide may depend on the material properties of the waveguide, such as its dielectric constant and conductivity. These material properties may affect the speed at which electromagnetic waves may propagate through the waveguide, which in turn affects the wavelength of the radiation. In addition, the wavelength λ may depend on the frequency of the electromagnetic radiation, e.g., the operating frequency of the RF chip 2. The wavelength of electromagnetic radiation in a waveguide may be inversely proportional to the frequency of the radiation, e.g., λ=c/f, wherein c is the speed of light, and f is the frequency of the radiation. It is to be understood that, in practice, the length of the first slot 30A may not necessarily exactly match a value of λ/2, but may be optimized or tuned with respect to one or more of the above mentioned properties. For example, the length of the first slot 30A can deviate from a value of λ/2 by less than about 20% or 15% or 10% or 5% or 4% or 3% or 2% or 1%.

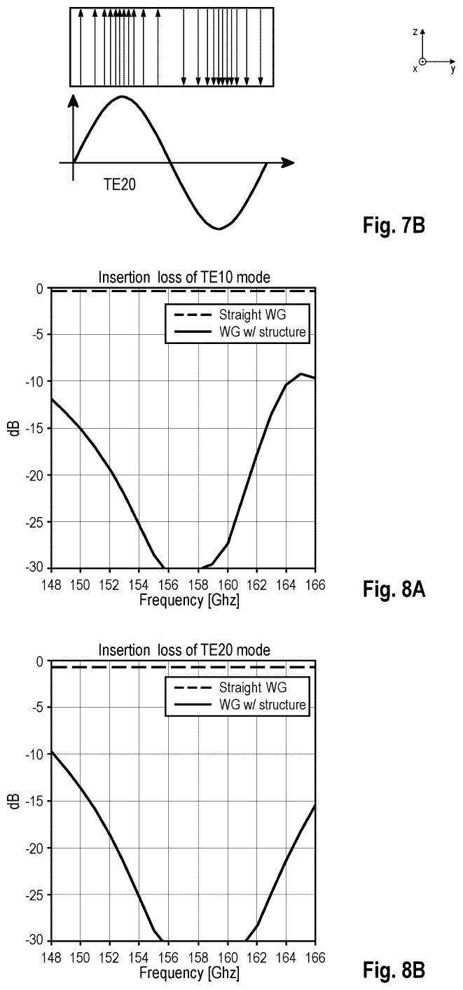

The first slot 30A may be aligned with a lobe of an electrical field distribution of a TE10 mode of the SIW 300. In this context, FIG. 7A illustrates an electrical field distribution of a TE10 mode of a waveguide such as the SIW 300, in particular when viewed in the x-direction. As can be seen from the example of FIG. 7A, a lobe or maximum of the electrical field distribution of the TE10 mode may be located in the center of the SIW 300 with respect to the y-direction. Accordingly, the first slot 30A may be centered or arranged in the middle of the first metal layer 24A with respect to the y-direction as can be seen from the top view of FIG. 3B.

Due to its length and positioning, the first slot 30A may be configured to suppress a second harmonic of an RF signal transmitted in the SIW 300 at an operating frequency of the RF chip 2. More particular, the first slot 30A may be configured to suppress the second harmonic of the TE10 mode. Stated differently, the first slot 30A may be configured to suppress the transmission of the TE10 mode in the SIW 300 at the frequency of the second harmonic. In this connection, a performance at the fundamental frequency band may be not necessarily affected. It is noted that the formation of a single slot in the first metal layer 24A may be seen as a most basic structure for suppressing the second harmonic of the TE10 mode. The first slot 30A may be configured as a resonator (or slot resonator) in the first metal layer 24A (e.g., the top surface) of the SIW 300. More particular, the first slot 30A may be configured to create a short circuit at the second harmonic of the RF signal and/or to reflect back the second harmonic of the RF signal. As will be discussed later on in connection with FIGS. 8A to 8C, the first slot 30A may be particularly configured to suppress a second harmonic of an RF signal transmitted in a waveguide in accordance with the disclosure at an operating frequency of the RF chip 2 better than about 10 dB in a 10% fractional bandwidth.

The SIW 300 may include a second plurality of second via connections 28B extending between the first metal layer 24A and the third metal layer 24C, wherein the second via connections 28B may at least partially surround the first slot 30A when viewed in a direction perpendicular to the first metal layer 24A, e.g., when viewed in the z-direction. The second via connections 28B and the third metal layer 24C may form an electrical shielding structure or electrical shielding cage at least partially surrounding the first slot 30A. The electrical shielding structure may be configured to shield and/or prevent radiation exiting the SIW 300 through the first slot 30A from penetrating into other areas of the RF package. A portion of the third metal layer 24C forming the top surface of the electrical shielding structure may be (in particular completely) closed, e.g., free from any openings. Accordingly, in practice, in the top view of FIG. 3B and in the perspective view of FIG. 3C the second via connections 28B may be covered by the third metal layer 24C and may thus not be visible. The same holds true for the first via connections 28A which are indicated by small dashed circles in the top view of FIG. 3B.

In the example top view of FIG. 3B, the second via connections 28B may be arranged in a rectangular shape. In this context, the second via connections 28B (or more particular the rectangle formed by the second via connections 28B) may include a first row of second via connections 28B arranged on the left of the first slot 30A and extending in the y-direction, a second row of second via connections 28B arranged on the right of the first slot 30A and extending in the y-direction, a third row of second via connections 28B arranged above the first slot 30A and extending in the x-direction, and a fourth row of second via connections 28B arranged below the first slot 30A and extending in the x-direction. In the illustrated example, the entirety of the second via connections 28B may fully surround the first slot 30A when viewed in the z-direction. That is, in the top view of FIG. 3B, the first slot 30A may be located completely within a region or area bounded by the second via connections 28B. In the illustrated example, the first slot 30A may not necessarily be centered in the rectangular shape of the second via connections 28B with respect to the x-direction, but may be slightly shifted to the right for tuning purposes.

In a further example, when viewed in the z-direction, the second via connections 28B may include the first and second row of second via connections 28B arranged on the left and the right of the first slot 30A, but may not necessarily include the third and fourth row of second via connections 28B arranged above and below the first slot 30A. In particular, the second via connections 28B may extend at least along both sides of the main portion of the first slot 30A when viewed in the z-direction. In the example top view of FIG. 3B this means that the second via connections 28B may at least extend to the left and to the right of the first slot 30A along the total length lₜₒₜₐₗ of the first slot 30A.

Referring now to FIG. 4, a top view of an SIW 400 is shown which may be included in an RF package in accordance with the disclosure such as the RF package 100 of FIG. 1. The SIW 400 of FIG. 4 may include some or all features of previously described waveguides. In the illustrated example, the first slot 30A may be u-shaped. That is, in the example top view of FIG. 4, the shape of the first slot 30A may resemble the shape of the letter “U”. In further examples, the first slot 30A may be formed differently, such as e.g., in a v-shape or in a c-shape. The u-shape of the first slot 30A may include one or multiple sharp corners and/or one or multiple rounded corners. In the illustrated example, the u-shape may have multiple sharp corners.

The u-shaped first slot 30A may include a first portion 32 having a first length of l₁ and extending in the y-direction, a second portion 34A having a second length of l₂ and extending in the x-direction, and a third portion 34B having a third length of l₃ and extending in the x-direction. Each of the second portion 34A and third portion 34B may be arranged substantially perpendicular to the first portion 32, and the second portion 34A and the third portion 34B may be substantially parallel to each other. In the shown case, l₂ may substantially equal l₃. In particular, the first length l₁ may be greater than each of the second length l₂ and the third length l₃, e.g., l₁>l₂ and l₁>l₃. Even more, the first length l₁ may be greater than the sum of the second length l₂ and the third length l₃, e.g., l₁>l₂+l₃. Accordingly, the first portion 32 may correspond to the main portion of the first slot 30A which may be arranged perpendicular to the propagation direction of the SIW 400. In the illustrated example, the u-shape of the first slot 30A may be opened to the left. Alternatively, the u-shape of the first slot 30A may be opened to the right in further examples.

Similar to the example of FIG. 3, a total length lₜₒₜₐₗ of the first slot 30A may substantially equal λ/2, wherein λ is an effective wavelength at the position of the first slot 30A associated with the second harmonic of an operating frequency of the RF chip 2. That is, in the illustrated example, lₜₒₜₐₗ=l₁+l₂+l₃≈λ/2. Again, the first slot 30A may be aligned with a lobe of an electrical field distribution of a TE10 mode of the SIW 400 such that the first slot 30A may be configured to suppress a second harmonic of an RF signal transmitted in the SIW 400 at an operating frequency of the RF chip 2. In particular, a u-shape (or v-shape or c-shape) of the first slot 30A may be used, if a dimension of the SIW 400 in the y-direction is too small or too short for a straight shaped first slot 30A. Stated differently, a u-shape (or v-shape or c-shape) of the first slot 30A may be more compact compared to a straight shape and may thus provide a smaller form factor of the shown arrangement compared to the arrangement of FIG. 3 where the first slot 30A has a similar total length lₜₒₜₐₗ , but is shaped as a straight line.

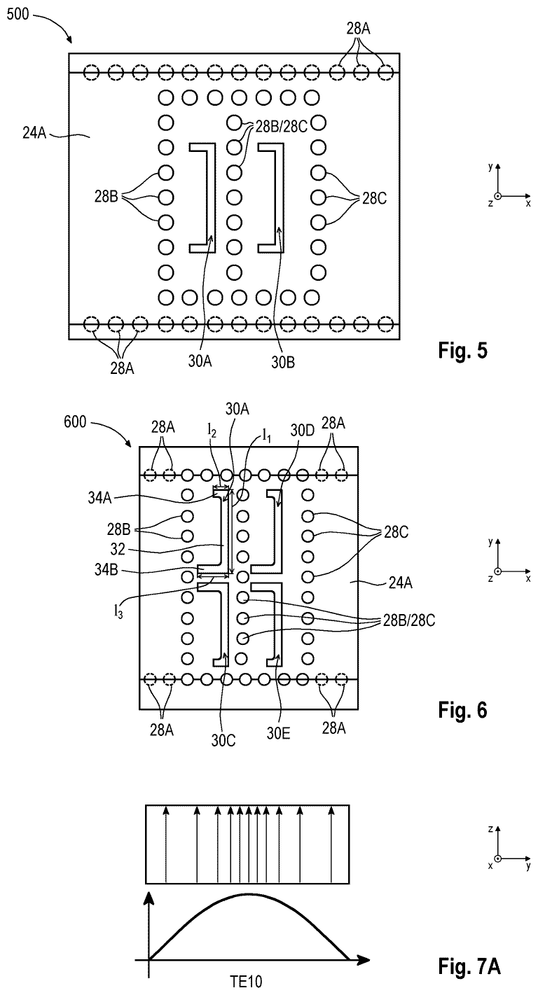

Referring now to FIG. 5, a top view of an SIW 500 is shown which may be included in an RF package in accordance with the disclosure such as the RF package 100 of FIG. 1. The SIW 500 of FIG. 5 may include some or all features of previously described waveguides. The SIW 500 may include a first slot 30A formed in the first metal layer 24A similar to the example of FIG. 4. In addition, the SIW 500 may include a second slot formed 30B in the first metal layer 24A, wherein the second slot 30B may be arranged adjacent to the first slot 30A with respect to a propagation direction of the SIW 500, e.g., with respect to the x-direction. Similar to the first slot 30A, the second slot 30B may be aligned with a lobe of an electrical field distribution of a TE10 mode of the SIW 500, and/or a length of the second slot 30B may substantially equal λ/2, wherein λ is an effective wavelength at the position of the second slot 30B associated with the second harmonic of an operating frequency of the RF chip 2. A formation of multiple slots in the first metal layer 24A may enhance a performance and/or may increase the bandwidth. Using only a single slot may provide only one notch in the frequency response, so that its bandwidth may be too limited for some applications. In contrast to this, multiple slots which may be slightly tuned to different but very close frequencies may be cascaded to increase the bandwidth. In the illustrated example, a structure including an example number of two slots is shown. However, in further examples, the number of slots may be increased. In the shown case, both slots 30A and 30B may have a similar shape such as a u-shape. In further examples, the shapes of the slots 30A and 30B may differ, wherein each slot 30A and 30B may be one of u-shaped, v-shaped, c-shaped, straight shaped, or the like.

The SIW 500 may include a third plurality of third via connections 28C extending between the first metal layer 24A and the third metal layer 24C. The third via connections 28C may at least partially surround the second slot 30B when viewed in the z-direction. The third via connections 28C may be similar to the second via connections 28B described in connection with FIG. 3. In particular, the third via connections 28C and the third metal layer 24C may form an electrical shielding structure or electrical shielding cage at least partially surrounding the second slot 30B. In the example top view of FIG. 5, each of the second via connections 28B and the third via connections 28C may be arranged in a rectangular shape. In the non-limiting case of FIG. 5, a first rectangle of the second via connections 28B surrounding the first slot 30A may be narrower with respect to the x-direction than a second rectangle of the third via connections 28C surrounding the second slot 30B. Such a deviation in the size of the two rectangles may be selected for tuning purposes. However, in a further example, the dimensions of the two rectangles may be identical. In particular, the third via connections 28C surrounding the second slot 30B and the second via connections 28B surrounding the first slot 30A may share a common row of via connections. The shared via connections may be arranged between the first slot 30A and the second slot 30B and may extend in the y-direction.

When measured in the x-direction, a distance between the first slot 30A and the second slot 30B may substantially equal λ/4, wherein λ is an effective wavelength at the location of at least one of the first slot 30A or the second slot 30B associated with an operating frequency of the RF chip 2. It is to be understood that, in practice, the distance between the slots 30A and 30B may not necessarily exactly match a value of λ/4, but may be optimized or tuned in order to improve the performance of the RF package and/or to suppress the second harmonic of the fundamental frequency band. For example, the distance between the slots 30A and 30B may deviate from λ/4 by less than about 20% or 15% or 10% or 5% or 4% or 3% or 2% or 1%.

Referring now to FIG. 6, a top view of an SIW 600 is shown which may be included in an RF package in accordance with the disclosure such as the RF package 100 of FIG. 1. The SIW 600 of FIG. 6 may include some or all features of previously described waveguides. The SIW 600 may include a first slot 30A formed in the first metal layer first metal layer 24A. In addition, the SIW 600 may include a third slot 30C formed in the first metal layer 24A, wherein the third slot 30C may be arranged adjacent to the first slot 30A with respect to a direction perpendicular to a propagation direction of the SIW 600, e.g., with respect to the y-direction. In the example top view of FIG. 6, the third slot 30C may be arranged below the first slot 30A.

In the non-limiting illustrated example, the first slot 30A may be u-shaped. In further examples, the first slot 30A may be formed differently, such as in a v-shape, a c-shape or a straight shape. The first length l₁ of the first portion 32 of the first slot 30A may be greater than each of the second length l₂ of the second portion 34A and the third length l₃ of the third portion 34B of the first slot 30A, e.g., l₁>l₂ and l₁>l₃. Even more, the first length l₃ may be greater than the sum of the second length l₂ and the third length 13, e.g., l₁>l₂+l₃. Accordingly, the first portion 32 may correspond to the main portion of the first slot 30A which may be arranged perpendicular to the propagation direction of the SIW 600. Furthermore, in the shown case, the second length l₂ of the second portion 34A may be smaller than the third length l₃ of the third portion 34B, e.g., l₂<l₃. In the example of FIG. 6, a total length lₜₒₜₐₗ of the first slot 30A may substantially equal λ/2, wherein λ is an effective wavelength at the position of the first slot 30A associated with the second harmonic of an operating frequency of the RF chip 2. That is, in the illustrated example, lₜₒₜₐₗ=l₁+l₂+l₃≈λ/2.

Similar to the first slot 30A, a total length lₜₒₜₐₗ of the third slot 30C may substantially equal λ/2. In the illustrated example, a shape of the third slot 30C may resemble the shape of the first slot 30A. In particular, the first slot 30A and the third slot 30C may be arranged substantially symmetrical to each other with respect to the x-direction. Alternatively, or additionally, the first slot 30A and the third slot 30C may have a symmetrical shape with respect to a symmetry axis parallel to the x-direction. However, in further examples, the shapes of the first slot 30A and the third slot 30C may differ. In one such further case, the first slot 30A may be u-shaped while the third slot 30C may be c-shaped, but a variety of multiple further cases may be contemplated.

The first slot 30A may be aligned with a first lobe of an electrical field distribution of a TE20 mode of the SIW 600, and the third slot 30C may be aligned with a second lobe of the electrical field distribution of the TE20 mode of the SIW 600. In this context, FIG. 7B illustrates an electrical field distribution of a TE20 mode of a waveguide such as the SIW 600, in particular when viewed in the x-direction. As can be seen from FIG. 7B, the electrical field distribution may include two lobes such that the first slot 30A and the third slot 30C may be formed in the first metal layer 24A accordingly. Due to such an alignment of the slots 30A and 30C with the lobes of the electrical field distribution, the slots 30A and 30C may be configured to suppress a second harmonic of an RF signal transmitted in the SIW 600 at an operating frequency of the RF chip 2. More particular, the slots 30A and 30C may be configured to suppress the second harmonic for the TE20 mode of the RF signal. In the previously discussed examples of FIGS. 3 to 5, the respective SIW included one or more slots formed in the middle or the center of the first metal layer 24A with respect to the y-direction. As previously described, such structures may be configured to suppress the second harmonic in the TE10 mode. However, such structures may be transparent to the second harmonics in the TE20 mode. In the example of FIG. 6, the slots 30A and 30C may be used side by side to suppress both of the TE10 and TE20 modes. In this context, the u-shape of the slots 30A and 30C may be asymmetric in order to optimize a suppression at both modes.

The SIW 600 may include a second plurality of second via connections 28B surrounding the first slot 30A. In addition, the second via connections 28B may at least partially surround the third slot 30C when viewed in the z-direction. That is, both slots 30A and 30C may be surrounded by the second via connections 28B. Similar to previous examples, the second via connections 28B may be arranged in a rectangular shape when viewed in the z-direction. In the illustrated example, the SIW 600 may optionally include a fourth slot 30D and a fifth slot 30E which may be arranged adjacent to the slots 30A and 30C with respect to the x-direction. In the shown case, the fourth slot 30D may be similar to the first slot 30A, while the fifth slot 30E may be similar to the third slot 30C. The fourth slot 30D and the fifth slot 30E may both be surrounded by a third plurality of third via connections 28C.

Referring now to FIGS. 8A to 8C, various insertion losses for a conventional waveguide and a waveguide in accordance with the disclosure such as the SIW 600 of FIG. 6 in particular are illustrated. In each of FIGS. 8A to 8C, a solid line relates to an insertion loss of a waveguide in accordance with the disclosure, while a dashed line relates to an insertion loss of a conventional waveguide.

FIG. 8A shows an insertion loss of the second harmonic for the TE10 mode, while FIG. 8B shows an insertion loss of the second harmonic for the TE20 mode. The center frequency of the second harmonic may be at twice the frequency of the fundamental frequency band. In the illustrated example, the center frequency of the second harmonic may be at approximately 158 GHz, such as in the example case of a 79 GHz frequency band as it may be used for automotive applications. As can be seen from the plots, a suppression of the waveguide in accordance with the disclosure for both modes may be better than about 15 dB in a 10 GHz band. That is, one or multiple slots formed in the first metal layer 24A as described in connection with previous examples may be configured to suppress a second harmonic of an RF signal transmitted in a waveguide better than about 10 dB in a 10% fractional bandwidth. Here, fractional bandwidth may be specified as the bandwidth divided by its center frequency. In addition, better than 10 dB may specify that the power of the second harmonic may be reduced to 1/10 or less.

FIG. 8C shows an insertion loss at the fundamental frequency band, more particular in the vicinity of the center frequency of about 79 GHz. As can be seen in the plot, the waveguide in accordance with the disclosure may increase the insertion loss less than about 0.1 dB which may be regarded as acceptable for most applications. Note that at the fundamental frequency only the TE10 mode is supported so that FIG. 8C only shows a single plot for the TE10 mode.

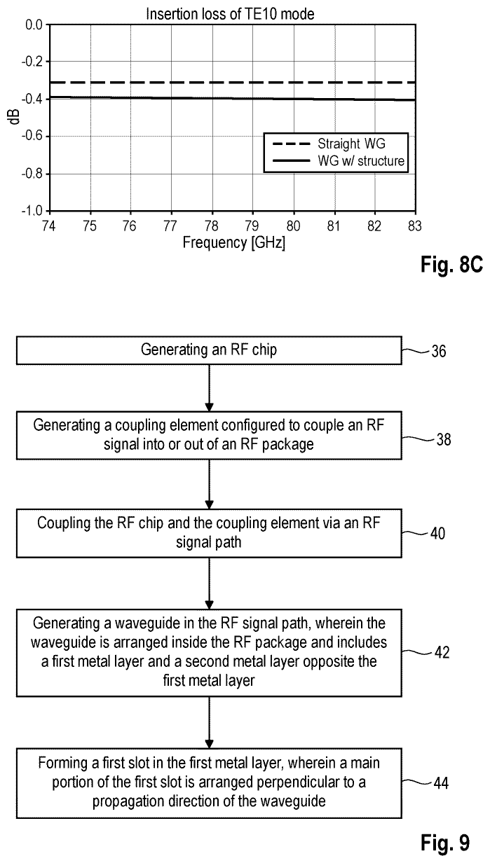

FIG. 9 illustrates a flowchart of a method for manufacturing an RF device in accordance with the disclosure. The method may be used for manufacturing RF devices as previously discussed and may thus be read in connection with any of the foregoing figures. The method of FIG. 9 is described in a general manner in order to qualitatively specify aspects of the disclosure. It is to be understood that the method may include further aspects. For example, the method may be extended by any of the aspects described in connection with other examples in accordance with the disclosure.

At 36, an RF chip may be generated. At 38, a coupling element configured to couple an RF signal into or out of the RF package may be generated. At 40, the RF chip and the coupling element may be coupled via an RF signal path. At 42, a waveguide may be generated in the RF signal path. The waveguide may be arranged inside the RF package and may include a first metal layer and a second metal layer opposite the first metal layer. At 44, a first slot may be formed in the first metal layer. A main portion of the first slot may be arranged perpendicular to a propagation direction of the waveguide

According to this description, RF packages including a waveguide in accordance with the disclosure may provide a simple and cost-efficient way to suppress a second harmonic of an RF signal transmitted in the waveguide and thus to suppress an important component of out-of-band radiation. Due to such a suppression of out-of-band radiation, a violation of EMI/EMC requirements may be avoided and a performance of the respective RF package may be improved. In contrast to this, conventional RF package may implement complex and costly precautions to suppress undesired out-of-band output. Therefore, RF packages in accordance with the disclosure may outperform conventional RF packages at least in this regard. It is to be noted that at least one of the shape of the used slot(s), the length of the used slot(s), the arrangement of the used via connections surrounding the slot(s), the position of the slot(s) with respect to the via connections may be adjusted, tuned or fine-tuned in order to achieve an optimized performance of the RF package including the waveguide and in particular to achieve a good suppression of the second harmonic of the fundamental frequency band. In this regard, the length of the slot(s) may be seen as a main tuning parameter. Furthermore, the number, the arrangement and the shape of the used slots may be determined based on the frequency of the RF signal, the suppression of the TE10/TE20 modes and the bandwidth.

The description of previous examples in accordance with the disclosure mainly referred to slots formed in the first metal layer 24A. Alternatively, or additionally, one or more slots for suppressing a second harmonic of an RF signal transmitted via the waveguide may be formed in the second metal layer 24B in further examples. In this regard, it is to be noted that due to the proximity of the second metal layer 24B to the PCB 16 and the electrical connection elements 18, the slots of the RF package may preferably be formed in the first metal layer 24A which is arranged further away from the PCB 16 and the electrical connection elements 18.

The description of previous examples in accordance with the disclosure mainly referred to the concept of SIWs. However, it is to be understood that this description and the aspects described therein are not limited to the concept of SIWs, but may also hold true for other waveguide types, such as air-filled waveguides. That is, in any of the previously described examples, one or more of the included SIWs may be replaced by another suitable type of waveguide such as e.g., an air-filled waveguide.

ASPECTS The aspects described herein provide RF packages and methods for manufacturing RF packages.

Aspect 1 is a radio frequency (RF) package, comprising: an RF chip; a coupling element configured to couple an RF signal into or out of the RF package; an RF signal path coupling the RF chip and the coupling element; and a waveguide arranged in the RF signal path, wherein the waveguide is arranged inside the RF package and comprises a first metal layer, a second metal layer opposite the first metal layer and a first slot formed in the first metal layer, wherein a main portion of the first slot is arranged perpendicular to a propagation direction of the waveguide.

Aspect 2 is an RF package of Aspect 1, wherein the waveguide is a substrate integrated waveguide and further comprises: a dielectric material arranged between the first metal layer and the second metal layer, and a first plurality of first via connections extending between the first metal layer and the second metal layer.

Aspect 3 is an RF package of Aspect 1 or 2, further comprising: a third metal layer arranged over the first metal layer; and a second plurality of second via connections extending between the first metal layer and the third metal layer, wherein the second via connections at least partially surround the first slot when viewed in a direction perpendicular to the first metal layer.

Aspect 4 is an RF package of Aspect 3, wherein the second via connections are arranged in at least two rows on opposite sides of the first slot when viewed in the direction perpendicular to the first metal layer.

Aspect 5 is an RF package of Aspect 3 or 4, wherein the second via connections extend at least along both sides of the main portion of the first slot when viewed in the direction perpendicular to the first metal layer.

Aspect 6 is an RF package of any of Aspects 3 to 5, wherein the second via connections fully surround the first slot when viewed in the direction perpendicular to the first metal layer.

Aspect 7 is an RF package of any of Aspects 3 to 6, wherein the second via connections and the third metal layer form an electrical shielding structure at least partially surrounding the first slot.

Aspect 8 is an RF package of any of the preceding Aspects, wherein a length of the first slot substantially equals λ/2, wherein λ is an effective wavelength at the position of the first slot associated with an operating frequency of the RF chip.

Aspect 9 is an RF package of any of the preceding Aspects, wherein the first slot is configured to suppress a second harmonic of an RF signal transmitted in the waveguide at an operating frequency of the RF chip.

Aspect 10 is an RF package of any of the preceding Aspects, wherein the first slot is configured to suppress a second harmonic of an RF signal transmitted in the waveguide at an operating frequency of the RF chip better than 10 dB in a 10% fractional bandwidth.

Aspect 11 is an RF package of any of the preceding Aspects, wherein the first slot has a straight shape.

Aspect 12 is an RF package of any of Aspects 1 to 10, wherein the first slot is u-shaped or c-shaped.

Aspect 13 is an RF package of any of the preceding Aspects, wherein the first slot is aligned with a lobe of an electrical field distribution of a TE10 mode of the waveguide.

Aspect 14 is an RF package of any of the preceding Aspects, further comprising: a second slot formed in the first metal layer, wherein the second slot is arranged adjacent to the first slot with respect to a propagation direction of the waveguide.

Aspect 15 is an RF package of Aspect 14, further comprising: a third plurality of third via connections extending between the first metal layer and a third metal layer, wherein the third via connections at least partially surround the second slot when viewed in a direction perpendicular to the first metal layer.

Aspect 16 is an RF package of Aspect 14 or 15, wherein the third via connections surrounding the second slot and the second via connections surrounding the first slot share a common row of via connections.

Aspect 17 is an RF package of any of Aspects 14 to 16, wherein a distance between the first slot and the second slot in a propagation direction of the waveguide substantially equals 24, wherein λ is an effective wavelength at the location of at least one of the first slot or the second slot associated with an operating frequency of the RF chip.

Aspect 18 is an RF package of any of Aspects 1 to 12, further comprising: a third slot formed in the first metal layer, wherein the third slot is arranged adjacent to the first slot with respect to a direction perpendicular to a propagation direction of the waveguide.

Aspect 19 is an RF package of Aspect 18, wherein the first slot and the third slot are arranged substantially symmetrical to each other with respect to the propagation direction of the waveguide.

Aspect 20 is an RF package of Aspect 18 or 19, wherein the first slot and the third slot have a symmetrical shape with respect to a symmetry axis parallel to the propagation direction of the waveguide.

Aspect 21 is an RF package of any of Aspects 18 to 20, wherein the second via connections surrounding the first slot at least partially surround the third slot when viewed in a direction perpendicular to the first metal layer.

Aspect 22 is an RF package of any of Aspects 18 to 21, wherein: the first slot is aligned with a first lobe of an electrical field distribution of a TE20 mode of the waveguide, and the third slot is aligned with a second lobe of the electrical field distribution of the TE20 mode of the waveguide.

Aspect 23 is an RF package of any of the preceding Aspects, further comprising: a substrate, wherein: the RF chip is arranged on a first main surface of the substrate, the coupling element is arranged at a second main surface of the substrate opposite the first main surface, and the waveguide is arranged in the substrate.

Aspect 24 is a method for manufacturing an RF package, the method comprising: generating an RF chip; generating a coupling element configured to couple an RF signal into or out of the RF package; coupling the RF chip and the coupling element via an RF signal path; generating a waveguide in the RF signal path, wherein the waveguide is arranged inside the RF package and comprises a first metal layer and a second metal layer opposite the first metal layer; and forming a first slot in the first metal layer, wherein a main portion of the first slot is arranged perpendicular to a propagation direction of the waveguide.

As employed in this specification, the terms “connected”, “coupled”, “electrically connected”, and/or “electrically coupled” may not necessarily mean that elements must be directly connected or coupled together. Intervening elements may be provided between the “connected”, “coupled”, “electrically connected”, or “electrically coupled” elements.

Further, the words “over” and “on” used with regard to e.g., a material layer formed or located “over” or “on” a surface of an object may be used herein to mean that the material layer may be located (e.g., formed, deposited, or the like) “directly on”, e.g., in direct contact with, the implied surface. The words “over” and “on” used with regard to e.g., a material layer formed or located “over” or “on” a surface may also be used herein to mean that the material layer may be located (e.g., formed, deposited, or the like) “indirectly on” the implied surface with e.g., one or multiple additional layers being arranged between the implied surface and the material layer.

Furthermore, to the extent that the terms “having”, “containing”, “including”, “with”, or variants thereof are used in either the detailed description or the claims, such terms are intended to be inclusive in a manner similar to the term “comprising”. That is, as used herein, the terms “having”, “containing”, “including”, “with”, “comprising”, and the like are open-ended terms that indicate the presence of stated elements or features, but do not preclude additional elements or features. The articles “a”, “an”, and “the” are intended to include the plural as well as the singular, unless the context clearly indicates otherwise.

Moreover, the words “example” and “aspect” are used herein to mean serving as an aspect, instance, or illustration. Any aspect or design described herein as “example” or “aspect” is not necessarily to be construed as advantageous over other aspects or designs. Rather, use of the words “example” and “aspect” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or multiple” unless specified otherwise or clear from context to be directed to a singular form. Also, at least one of A and B or the like generally means A or B or both A and B.

Although specific aspects have been illustrated and described herein, it will be appreciated by those of ordinary skill in the art that a variety of alternate and/or equivalent implementations may be substituted for the specific aspects shown and described without departing from the scope of the present implementation. This application is intended to cover any adaptations or variations of the specific aspects discussed herein. Therefore, it is intended that this implementation be limited only by the claims and the equivalents thereof.

It should be noted that the methods and devices including its preferred implementations as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the implementation and are included within its spirit and scope. Furthermore, all aspects and implementations outlined in the present document are principally intended expressly to be only for explanatory purposes to help the reader in understanding the principles of the proposed methods and systems. Furthermore, all statements herein providing principles, aspects, and implementations of the implementation, as well as specific aspects thereof, are intended to encompass equivalents thereof.

1. A radio frequency (RF) package, comprising:
an RF chip;
a coupling element configured to couple an RF signal into or out of the RF package;
an RF signal path coupling the RF chip and the coupling element; and
a waveguide arranged in the RF signal path,
wherein the waveguide is arranged inside the RF package and comprises a first metal layer, a second metal layer opposite the first metal layer and a first slot formed in the first metal layer,
wherein a main portion of the first slot is arranged perpendicular to a propagation direction of the waveguide.

2. The RF package of claim 1, wherein the waveguide is a substrate integrated waveguide and further comprises:
a dielectric material arranged between the first metal layer and the second metal layer, and
a first plurality of first via connections extending between the first metal layer and the second metal layer.

3. The RF package of claim 1, further comprising:
a third metal layer arranged over the first metal layer; and
a second plurality of second via connections extending between the first metal layer and the third metal layer, wherein the second via connections at least partially surround the first slot when viewed in a direction perpendicular to the first metal layer.

4. The RF package of claim 3, wherein the second via connections are arranged in at least two rows on opposite sides of the first slot when viewed in the direction perpendicular to the first metal layer.

5. The RF package of claim 3, wherein the second via connections extend at least along both sides of the main portion of the first slot when viewed in the direction perpendicular to the first metal layer.

6. The RF package of claim 3, wherein the second via connections fully surround the first slot when viewed in the direction perpendicular to the first metal layer.

7. The RF package of claim 3, wherein the second via connections and the third metal layer form an electrical shielding structure at least partially surrounding the first slot.

8. The RF package of claim 1,
wherein a length of the first slot substantially equals λ/2,
wherein λ is an effective wavelength at a position of the first slot associated with an operating frequency of the RF chip.

9. The RF package of claim 1, wherein the first slot is configured to suppress a second harmonic of an RF signal transmitted in the waveguide at an operating frequency of the RF chip.

10. The RF package of claim 1, wherein the first slot is configured to suppress a second harmonic of an RF signal transmitted in the waveguide at an operating frequency of the RF chip better than 10 dB in a 10% fractional bandwidth.

11. The RF package of claim 1, wherein the first slot has a straight shape.

12. The RF package of claim 1, wherein the first slot is u-shaped or c-shaped.

13. The RF package of claim 1, wherein the first slot is aligned with a lobe of an electrical field distribution of a TE10 mode of the waveguide.

14. The RF package of claim 3, further comprising:
a second slot formed in the first metal layer, wherein the second slot is arranged adjacent to the first slot with respect to a propagation direction of the waveguide.

15. The RF package of claim 14, further comprising:
a third plurality of third via connections extending between the first metal layer and a third metal layer, wherein the third via connections at least partially surround the second slot when viewed in a direction perpendicular to the first metal layer.

16. The RF package of claim 14, wherein the third via connections at least partially surrounding the second slot and the second via connections at least partially surrounding the first slot share a common row of via connections.

17. The RF package of claim 14, wherein a distance between the first slot and the second slot in a propagation direction of the waveguide substantially equals λ/4,
wherein λ is an effective wavelength at a location of at least one of the first slot or the second slot associated with an operating frequency of the RF chip.

18. The RF package of claim 3, further comprising:
a third slot formed in the first metal layer, wherein the third slot is arranged adjacent to the first slot with respect to a direction perpendicular to a propagation direction of the waveguide.

19. The RF package of claim 18, wherein the first slot and the third slot are arranged substantially symmetrical to each other with respect to the propagation direction of the waveguide.

20. The RF package of claim 18, wherein the first slot and the third slot have a symmetrical shape with respect to a symmetry axis parallel to the propagation direction of the waveguide.

21. The RF package of claim 18, wherein the second via connections at least partially surrounding the first slot at least partially surround the third slot when viewed in a direction perpendicular to the first metal layer.

22. The RF package of any claim 18, wherein:
the first slot is aligned with a first lobe of an electrical field distribution of a TE20 mode of the waveguide, and
the third slot is aligned with a second lobe of the electrical field distribution of the TE20 mode of the waveguide.

23. The RF package of claim 1, further comprising:
a substrate, wherein:
the RF chip is arranged on a first main surface of the substrate,
the coupling element is arranged at a second main surface of the substrate opposite the first main surface, and
the waveguide is arranged in the substrate.

24. A method for manufacturing an RF package, the method comprising:
generating an RF chip;
generating a coupling element configured to couple an RF signal into or out of the RF package;
coupling the RF chip and the coupling element via an RF signal path;
generating a waveguide in the RF signal path, wherein the waveguide is arranged inside the RF package and comprises a first metal layer and a second metal layer opposite the first metal layer; and
forming a first slot in the first metal layer, wherein a main portion of the first slot is arranged perpendicular to a propagation direction of the waveguide.
